(19) United States
(12) Patent Application Publication
(10) Pub. No.: US 2020/0122372 A1
(43) Pub. Date: Apr. 23, 2020

(54) MOULDING METHOD AND APPARATUS

(71) Applicant: ABGENE LTD, Carlsbad, CA (US)

(72) Inventors: DANIEL SIMS, ASHFORD (GB); CLIVE HARRISON, ASHFORD (GB); PETER PRYCE, UCKFIELD (GB)

(21) Appl. No.: 16/604,503

(22) PCT Filed: Jan. 30, 2018
(86) PCT No.: PCT/GB2018/050264

§ 371 Date: Oct. 10, 2019

(30) Foreign Application Priority Data
Apr. 10, 2017 (GB) 1705760.5

(51) Int. Cl. B29C 45/26; B29C 45/00; B01L 3/00

(52) U.S. Cl. CPC B29C 45/2669; B29K 2023/12; B01L 3/5085; B29C 45/0046

(57) ABSTRACT

This invention relates to a mould tool and method for forming a polypropylene PCR plate comprising a channel, a main body and an overflow area; wherein the channel is configured to facilitate the introduction of molten plastics material into the main body and wherein the main body is configured to facilitate the flow of the said molten plastics into the overflow area once the main body of the mould tool has been filled with the said molten plastics.

### FIELD OF THE INVENTION

This invention relates to a moulding tool and method for forming a polypropylene PCR plate comprising a channel, a main body and an overflow area; wherein the channel is configured to facilitate the introduction of molten plastics material into the main body and wherein the main body is configured to facilitate the flow of the said molten plastics into the overflow area once the main body of the moulding tool has been filled with the said molten plastics.

### BACKGROUND OF THE INVENTION

Current injection moulding apparatus and methods involve molten plastics material being injected into a mould (also called a mould tool or simply tool) from one or more nozzles through one or more channels in the mould called runners. The molten plastics material flows through the one or more runners into the main body of the mould. Once the entire volume of the mould is filled the one or more nozzles will cease injecting the molten plastics material into the one or more runners and thus into the main body of the mould and the mould will usually at that stage be opened (either automatically or manually) to eject the moulded part from the main body of the mould and the mouldings from the one or more runners from the mould.

The problem with using this method and moulding apparatus for the mouldings of plastics materials for use in products which have sections of varying thickness, such as PCR plates, is that air can become trapped in the plastics material, flow is not always consistent from thicker areas of plastics material to thinner areas of plastics material and the finished moulded plastics material products are not always flat, which can lead to a substantial scrappaged of finished moulded plastics material products.

### SUMMARY OF THE INVENTION

According to a first aspect of the invention there is provided a mould tool configured to form a polypropylene PCR plate comprising a channel, a main body and an overflow area; wherein the channel is configured to facilitate the introduction of molten polypropylene plastics material into the main body and wherein the main body is configured to facilitate the flow of the said molten polypropylene plastics into the overflow area once the main body of the mould tool has been filled with the said molten plastics wherein the main body is open only to the channel and the overflow area, wherein the overflow area is only open to the main body such that the only entrance/exit to the mould tool is via the channel. This is advantageous since the flow pattern from thick to thin areas is improved and any air that may be trapped in the molten plastics material is forced into the overflow area rather than remaining in the main body of the mould. This results in the finished moulded plastic product being flatter and without air bubbles, which in turn results in a reduction in plastic product that needs to be scrapped. The main body of the mould tool comprises portions configured to create thick areas and thin areas in the said polypropylene PCR plate.

Preferably the mould tool is configured for standard injection moulding techniques. This is advantageous as the mould can be simply used in standard injection moulding appliances without the need for additional specialised equipment.

Preferably the channel is configured to facilitate the introduction of only molten polypropylene plastics material into the main body of the mould tool.

Preferably the thick areas are in the range of 0.90 mm to 1.50 mm.

Preferably the thin areas are in the range of 0.15 mm to 0.30 mm.

Preferably the channel is configured to facilitate the introduction of molten polypropylene plastics material into the portions configured to create thick areas in the said polypropylene PCR plate of the main body.

Preferably the main body is configured to facilitate the flow of the said molten polypropylene plastics material from the portions configured to create thick areas in the said polypropylene PCR plate into the portions configured to create thin areas in the said polypropylene PCR plate.

Preferably the main body is configured to facilitate the flow of the said molten polypropylene plastics material from the portions configured to create thin areas in the said polypropylene PCR plate into the overflow area.

Preferably the overflow area is configured to create a scrap product.

Preferably the channel is configured to create a scrap product.

Preferably the main body is configured to create the said plastics product.

Preferably the overflow area is configured to create a scrap product which is of greater thickness than the portions of the main body configured to create thin areas in the said polypropylene PCR plate.

Preferably the mould tool is configured to form a 24 well PCR plate.

Preferably the mould tool is configured to form a 32 well PCR plate.

Preferably the mould tool is configured to form a 48 well PCR plate.

Preferably the mould tool is configured to form a 96 well PCR plate.

Preferably the mould tool is configured to form a 384 well PCR plate.

Preferably the portions of the main body that are configured to create thick areas in the said plastics product are configured to create the deck of the said PCR plate.

Preferably the portions of the main body that are configured to create thick areas in the said plastics product are configured to create the deck and skirt of the said PCR plate.

Preferably the portions of the main body that are configured to create thin areas in the said plastics product are configured to create the wells of the said PCR plate.

Preferably the main body is configured to facilitate the flow of the said molten polypropylene plastics material from the portions configured to create the bottoms of the wells in the said PCR plate into the overflow area.

According to a second aspect of the present invention there is provided a method of injection moulding a polypropylene PCR plate comprising the steps of
a) providing a mould tool as described in relation to the first aspect of the invention;
b) introducing molten polypropylene plastics material into the main body of the mould tool through the channel, such that once the main body of the mould tool is filled, the molten polypropylene plastics material is configured to fill the overflow area;
c) ejecting the polypropylene PCR plate from the mould along with the moulding of the channel and the overflow area;
d) discarding the moulding of the channel and the overflow area.

Preferably the injection moulding is standard injection moulding. This is advantageous as the method can be simply used in standard injection moulding appliances without the need for additional specialised equipment.

Preferably only molten polypropylene plastics material is introduced into the mould tool during the moulding process.

Preferably the mould is not put under external pressure.

### BRIEF DESCRIPTION OF THE DRAWINGS

Other aspects and features of the present invention will become apparent to those ordinarily skilled in the art upon review of the following description of specific embodiments of the invention in conjunction with the accompanying figures.

FIG. 1 illustrates a typical injection mould press;

FIG. 2 illustrates a close up cross-sectional view of a portion of the mould tool in a closed position;

FIG. 3 illustrates a cross-sectional view of a portion of the mould tool in an open position;

FIG. 4 illustrates plan views of examples of the moulded plastics product and the scrap products; and

FIG. 5 illustrates perspective views of examples of the moulded plastics product and the scrap products.

### DETAILED DESCRIPTION OF PREFERRED EMBODIMENTS

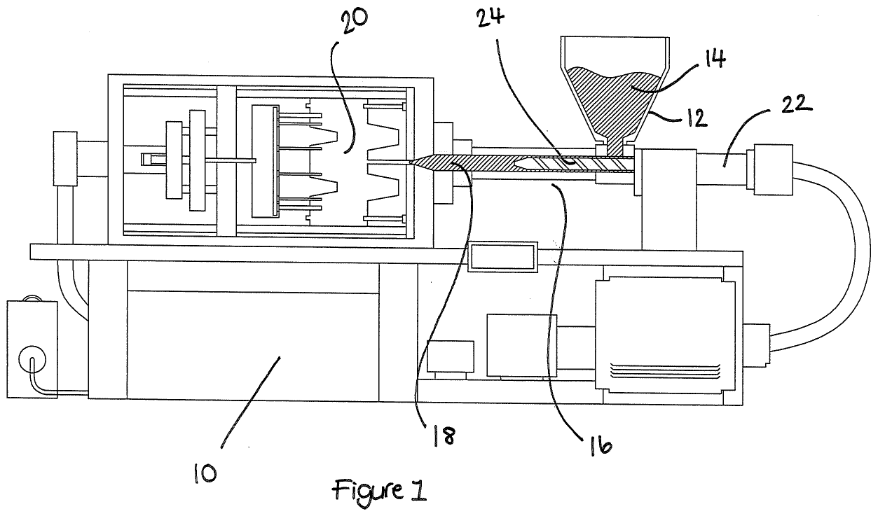

FIG. 1 illustrates a typical injection moulding assembly 10, which is known as an injection mould press 10. The mould tool 20 is mounted in such an injection mould press 10. Solid plastics material 14 is held in a hopper 12, and fed into a heated barrel 16 and mixed to form a molten plastics material 18 before being forced into the mould tool 20. The solid/molten plastics material 14, 18 is mixed in the heated barrel 16 typically using a rotating screw thread 24. The molten plastics material 18 is typically forced into the mould tool 20 by a pressing ram 22 which may be hydraulically operated. The injection mould press may comprises more than one hopper 12, if different plastics materials need to be fed into the mould tool 20, either together or sequentially. The injection mould press 10 may have one or more heated barrels 16 or into the alternative the heated barrel 16 may split into a plurality of heated barrels.

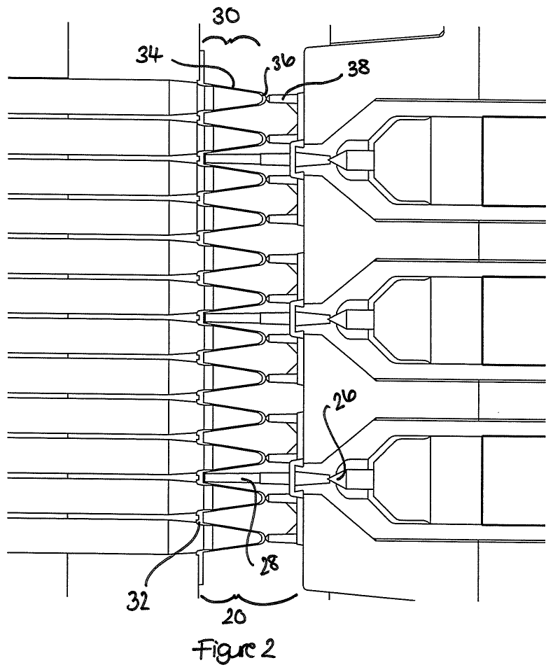

FIG. 2 illustrates a close up cross-sectional view of a portion of the injection mould press 10 with the mould tool 20 in a closed position. FIG. 2 illustrates where the heated barrel 16 terminates in a nozzle 26 inside the mould tool 20. Mould tool 20 comprises a channel 28, a main body 30 and an overflow area 38. Molten plastics material 18 leaves the heated barrel 16 via nozzle 26 and is injected into the mould tool 20 through channel 28. Once channel 28 is filled with molten plastics material 18 the molten plastics material 18 continues to be forced into the main body 30 of the mould tool 20. In the embodiment illustrated the mould tool 20 is for forming a PCR plate. A typical PCR plate comprises a deck portion and a plurality of wells, the PCR plate may optionally comprise a skirt portion which may be a full skirt or a semi or half skirt if present. The deck portion and the skirt portion if present are of much greater thickness of plastics material than the plurality of wells. The mould tool therefore needs to have portions for creating the thicker deck portion and skirt portion if present and portions for creating the thinner wells. Typically once the molten plastics material 18 has been injected into channel 28 the molten plastics material 18 is first forced into the thicker areas 32 of the main body 30 of the mould tool 20, which in the case of a PCR plate mould are the areas that form the deck portion. Once the thicker areas 32 of the main body 30 of the mould tool 20 are filled with molten plastics material 18, the molten plastics material 18 is then forced from the thicker areas 32 of the main body 30 of the mould tool 20 into the thinner areas 34 of the main body 30 of the mould tool 20, which in the case of a PCR plate mould are the areas that form the wells. In a traditional injection moulding process this is where the procedure would then stop and the finished plastics product would be ejected from the mould. However, in the case of the present invention the procedure continues such that once the thinner areas 34 of the main body 30 of the mould tool 20 are filled with molten plastics material 18, the molten plastics material 18 is then forced from the thinner areas 34 of the main body 30 of the mould tool 20 through an exit point 36, which in the case of a PCR plate mould is the point that form the bottoms of the wells, into overflow area 38. Overflow area 38 and channel 28 are configured to produce scrap products of similar thickness to each other such the complete flow of molten plastics material is from a substantially thick area being channel 28, to a thinner area 32 which in the case of a PCR plate would form the deck, to a substantially thinner area 34 which in the case of a PCR plate would form the wells, finally to a further substantially thick area being overflow area 38. The mould tool 20 comprising a final substantially thick area being overflow area 38 allows for any air trapped in the molten plastics material to be forced into this final area rather than remaining in the moulding of the plastics product, in addition the plastic flow pattern is improved flowing from thick to thin areas as there is this final thick area after the very thin area.

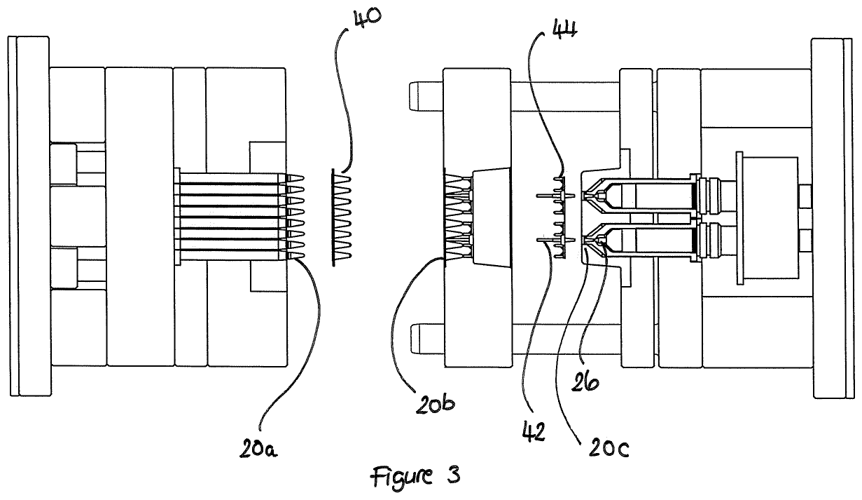

FIG. 3 illustrates a cross-sectional view of a portion of the mould tool 20 in an open position. As can be seen in FIG. 3 the mould tool 20 comprises three physical portions 20a, 20b and 20c which when connected together create void spaces which comprise channel 28, main body 30 and overflow area 38. Whilst in the embodiment illustrated the mould tool 20 comprises three physical portions 20a, 20b and 20c, in an alternate embodiment may comprise less than or more than three physical portions, depending on the complexity of the mould tool 20 and the product to be moulded. In the embodiment illustrated for ease of processing, the plastics product being moulded 40 is configured to eject from one side of the mould tool 20 between physical portions 20a and 20b of the mould tool 20, whilst the scrap products 42, 44 being the mouldings from the channel 28 and overflow area 38 respectively are configured to eject from the other side of the mould tool 20 between physical portions 20b and 20c of the mould tool. This enables ejected mouldings to be sorted into keeping and scrapping bins without additional user input.

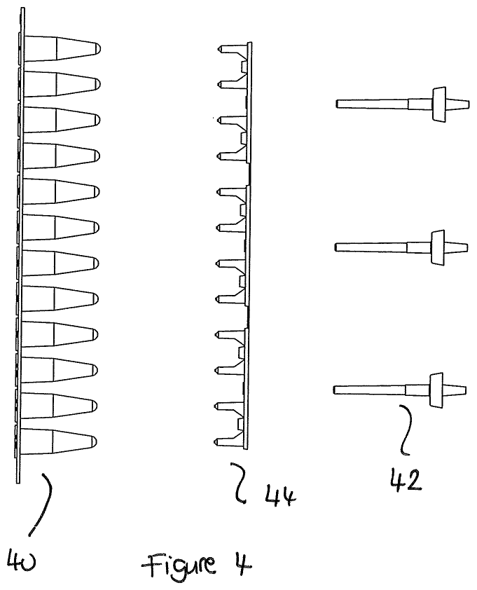

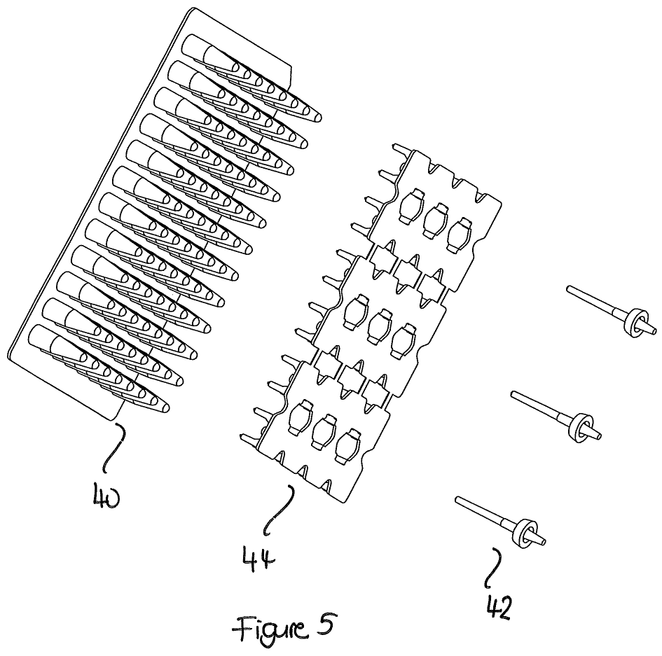

FIGS. 4 and 5 illustrate examples of the moulded plastics product 40 and the scrap products 42, 44 being the mouldings from the channel 28 and overflow area 38 respectively.

1. A mould tool configured to form a polypropylene PCR plate comprising a channel, a main body and an overflow area; wherein the channel is configured to facilitate the introduction of molten polypropylene plastics material into the main body and wherein the main body is configured to facilitate the flow of the said molten polypropylene plastics into the overflow area once the main body of the mould tool has been filled with the said molten polypropylene plastics wherein the main body is open only to the channel and the overflow area, wherein the overflow area is only open to the main body such that the only entrance/exit to the mould tool is via the channel, wherein the main body of the mould tool comprises portions configured to create thick areas and thin areas in the said polypropylene PCR plate.

2. A mould tool as claimed in claim 1 configured for standard injection moulding.

3. A mould tool as claimed in claim 1 or claim 2 wherein the channel is configured to facilitate the introduction of only molten polypropylene plastics material into the main body of the mould tool.

4. A mould tool as claimed in any preceding claim wherein the thick areas are in the range of 0.90 mm to 1.50 mm.

5. A mould tool as claimed in any preceding claim wherein the thin areas are in the range of 0.15 mm to 0.30 mm.

6. A mould tool as claimed in any preceding claim wherein the channel is configured to facilitate the introduction of molten polypropylene plastics material into the portions configured to create thick areas in the said polypropylene PCR plate of the main body.

7. A mould tool as claimed in any preceding claim wherein the main body is configured to facilitate the flow of the said molten polypropylene plastics material from the portions configured to create thick areas in the said polypropylene PCR plate into the portions configured to create thin areas in the said polypropylene PCR plate.

8. A mould tool as claimed in any preceding claim wherein the main body is configured to facilitate the flow of the said molten polypropylene plastics material from the portions configured to create thin areas in the said polypropylene PCR plate into the overflow area.

9. A mould tool as claimed in any preceding claim wherein the overflow area is configured to create a scrap product.

10. A mould tool as claimed in any preceding claim wherein the channel is configured to create a scrap product.

11. A mould tool as claimed in any preceding claim wherein the main body is configured to create the said polypropylene PCR plate.

12. A mould tool as claimed in any preceding wherein the overflow area is configured to create a scrap product which is of greater thickness than the portions of the main body configured to create thin areas in the said polypropylene PCR plate.

13. A mould tool as claimed in any preceding claim wherein the mould tool is configured to form a 24 well PCR plate.

14. A mould tool as claimed in any preceding claim wherein the mould tool is configured to form a 32 well PCR plate.

15. A mould tool as claimed in any preceding claim wherein the mould tool is configured to form a 48 well PCR plate.

16. A mould tool as claimed in any preceding claim wherein the mould tool is configured to form a 96 well PCR plate.

17. A mould tool as claimed in any preceding claim wherein the mould tool is configured to form a 384 well PCR plate.

18. A mould tool as claimed in any preceding claim wherein the portions of the main body that are configured to create thick areas in the said polypropylene PCR plate are configured to create the deck of the said PCR plate.

19. A mould tool as claimed in any preceding claim wherein the portions of the main body that are configured to create thick areas in the said polypropylene PCR plate are configured to create the deck and skirt of the said PCR plate.

20. A mould tool as claimed in any preceding claim wherein the portions of the main body that are configured to create thin areas in the said plastics product are configured to create the wells of the said PCR plate.

21. A mould tool as claimed in any preceding claim wherein the main body is configured to facilitate the flow of the said molten plastics material from the portions configured to create the bottoms of the wells in the said PCR plate into the overflow area.

22. A method of injection moulding a polypropylene PCR plate comprising the steps of
a) providing a mould tool as claimed in any of claims 1 to 21
b) introducing molten polypropylene plastics material into the main body of the mould tool through the channel, such that once the main body of the mould tool is filled, the molten polypropylene plastics material is configured to fill the overflow area;
c) ejecting the polypropylene PCR plate from the mould along with the moulding of the channel and the overflow area;
d) discarding the moulding of the channel and the overflow area.

23. A method as claimed in claim 22 wherein the injection moulding is standard injection moulding.

24. A method as claimed in claim 22 or claim 23 wherein only molten polypropylene plastics material is introduced into the mould tool during the moulding process.

25. A method as claimed in any of claims 22 to 24 wherein the mould is not put under external pressure.
